(19) United States
(12) Patent Application Publication
(10) Pub. No.: US 2005/0207357 A1
(43) Pub. Date: Sep. 22, 2005

(54) Multipoint conferencing system employing IP network and its configuration method

(75) Inventor: Takahiro Koga, Tokyo (JP)

Correspondence Address: FOLEY AND LARDNER;SUITE 500, 3000 K STREET NW, WASHINGTON, DC, 20007, US

(73) Assignee: NEC Personal Products, Ltd.

(21) Appl. No.: 11/079,215

(22) Filed: Mar. 15, 2005

(30) Foreign Application Priority Data
Mar. 19, 2004 (JP) 2004-080360

(51) Int. Cl. H04L 12/28; H04L 12/54

(52) U.S. Cl. 370/260; 370/389; 370/428

(57) ABSTRACT

A multipoint conferencing system for allowing a conference to be held among a plurality of terminals capable of making communication via an IP network includes: a telephone conference server for, out of said plurality of said terminals, recognizing the terminal participating in the conference as a terminal belonging to either a speaker group or a listener group, and for generating audio data by making a mixing of audio data from the terminal belonging to said speaker group; and a audio delivering section for delivering the audio data for which a mixing was made by said telephone conference server to terminals belonging to said speaker group and said listener group. Further, the terminal is made movable between the speaker group and listener group.

### BACKGROUND OF THE INVENTION

The present invention relates to a telephone conferencing system employing a network and its configuration system, and more particularly to a multipoint conferencing system employing an IP network of a many-participant type, which has the terminals arranged at a plurality of points, and its configuration method.

Recently, an IP telephone of which a call between companions of an identical network/provider/terminal is basically free of charge has prevailed. In such a telephone, it can be thought that the IP network to be utilized for a connection thereof, which is a packet switching network, is utilized for telephone-conference-manner communication of a many-participant type because its multicast function can be employed. This system of the IP telephone (hereinafter, referred to as a terminal), in which a one-to-one call is normally made between the terminals, is a system for, by expanding this function to make a connection between each of a plurality of the terminals and the other, enabling a conference at which many persons participate to be held.

The method shown in FIG. 15 is listed as a first method of the conventional example of this type. In the example shown in FIG. 15, each of all terminals A to C participating in the conference mutually transmits/receives audio data to/from all of the other call companions via an internet/IP network.

The characteristic of this method lies in that the telephone conferencing system can be constructed only by a functional expansion on the terminal side, and that no special server for constructing the telephone conferencing system is required.

Also, there exists the method employing a multipoint connection server as a second method. As shown in FIG. 16, this is a method of, in a case where each of the terminals A to C makes a speech, transmitting the audio data to the multipoint connection server to make a mixing (synthesis) of the audio data spoken at each terminal participating in the conference by the multipoint connection server, and to transmit this one kind of the audio data, for which a mixing was made, to each terminal.

The characteristic of this method lies in that also in a case where the participant number of the telephone conference increases, a throughput at each terminal participating in the conference is the same as the case of one-to-one communication.

Also, as a third method, there exists the method employing a multipoint connection server to be disclosed in the patent document 1 (Publication of U.S. Pat. No. 2,970,645). As shown in FIG. 17, this is a method of detecting a processing load of each terminal participating in the telephone conference by a multipoint connection server 100 to control a audio data packet, which is transmitted from the multipoint connection server, based upon the above processing load information.

The characteristic of this method lies in, before the processing load at the terminal participating in the telephone conference nears to a limit of its ability, suppressing an increase in the processing load at its terminal, which makes it possible to suppress a delay accompanied by the processing on the side of the terminal that received the audio data.

Also, as a fourth method, is listed another method to be disclosed in the patent document 1. As shown in FIG. 18, this is a method of detecting a time of a audio data arrival (delay) at each terminal participating in the telephone conference by a multipoint connection server 1000 to control a audio data packet, which is transmitted from the multipoint connection server, based upon the above arrival time information.

The speakers increase and the audio data packet to be transmitted augments correspondingly, whereby a delay due to tightness occurs in some cases, depending upon the status of a transmission line, and the characteristic of this method lies in that occurrence of such a problem can be avoided in advance by changing a transfer method of the audio data packet to be transmitted, based upon the above arrival time information.

Also, as a fifth method, there exists the method to be disclosed in the patent document 2 (Publication of U.S. Pat. No. 3,457,202). As shown in FIG. 19, this is a method of, on the assumption that even though the multipoint connection server is employed, a mixing of the audio data is not made in the multipoint connection server, regarding a predetermined terminal as a speaker, thereby to perform a process of distributing only the audio data coming from the above speaker's terminal to all of the other terminals participating in the conference for transmission, and a process of switching the speaker.

The characteristic of this method lies in that the multipoint connection server does not make a mixing of the audio data, whereby a throughput in the multipoint connection server is fewer as compared with that of the second method.

Also, as a sixth method, as shown in FIG. 20, there exists the method of controlling audio communication between each of the terminals participating in the conference and the other so that even though the multipoint connection server is employed, it is only one-to-one communication that is concurrently made.

The characteristic of this method lies in that the multipoint connection server performs only a process of switching the speaker, whereby a throughput in the multipoint connection server is fewer as compared with that of the fifth method to the extent that a process is spared of distributing the audio data coming from the speaker's terminal to all of the other terminals participating in the conference for transmission.
[Patent document 1] Publication of U.S. Pat. No. 2,970,645
[Patent document 2] Publication of U.S. Pat. No. 3,457,202

Of the forgoing methods conventionally performed, the first method has not only the controversial point that as the number of the terminals participating in the conference increases, the throughput at each terminal augments and exceeds a processing ability thereof, but also the controversial point that as the number of the terminal participating in the conference increases, the data amount flowing within the network also augments. For example, with a one-to-one call, two kinds of the audio data, which are speech audio data of both terminals, flow at a bi-direction; however when the number of the terminals participating in the conference is three, each terminal has to transmit the audio data, which the terminal itself spoke, to the remaining (3−1=2) two terminals, so 2×3=6 kinds of the audio data result in flowing, likewise, with four terminals, 3×4=12 kinds of the audio data, that is, in case where the number of the participants is N, (N−1)×N kinds of the audio data flow therein, which causes the data amount to augment.

Also, one kind of the audio data for which a mixing was made by the multipoint connection server is transmitted to each terminal in the second method, thereby making it possible to solve the controversial point in the above-mentioned first method; however realization of the system necessitates performing a process of expanding a plurality of kinds of the once-received audio data in the multipoint connection server, next to make a mixing of a plurality of kinds of the expanded audio data, further to re-compress this audio data for which a mixing was made, and to transmit it to each terminal because it is impossible to make a mixing of the compressed audio data as it stands in the current technology. For this, the throughput in the multipoint connection server augments remarkably. Executing this process in the multipoint connection server causes a delay to occur to the audio data to be sent from the multipoint connection server due to an augmentation in the processing time, so the problem exists that it becomes difficult to hold the conference itself. Also, so as to solve this problem, employing the multipoint connection server having a high processing ability gives rise to the controversial point newly that the price of the system becomes high.

Further, so as to solve the controversial point of the above-mentioned first method, the third method and the fourth method may be considered; however in either method, expansion routines by the number of the terminals, which are currently transmitting the speech audio data packet in the telephone conference, have to be started, so the controversial point exists that the data amount flowing in the network and the processing load of the multipoint connection server also augment as the speech terminals increase in the telephone conference.

Further, so as to solve the above-mentioned problem, the fifth method may be considered; however in this case, it is only one terminal that can transmit the speech audio data simultaneously, which brings about the controversial point that a degree of usability is remarkably lowered. In particular, the call results in being of half-duplex communication in terms of the interval, so there exists the problem that a degree of usability is remarkably lowered and a stress placed upon the conference participant augments.

Further, so as to solve the above-mentioned problem, the sixth method may be considered; however in this case, the number of the terminals, which are allowed to transmit the speech audio data simultaneously, is only two after all is said and done, so there exist the controversial point that although the extent to which a degree of usability is lowered in the sixth method is not worse than that of the fifth method, after all, it is remarkably lowered. In particular, even though the call is of full-duplex communication, the number of the terminals, which are allowed to transmit/receive the speech audio data at an identical time, is limited to two after all, whereby although the extent to which a degree of usability is lowered in the sixth method is not worse than that of the third method, after all is said and done, it is remarkably lowered, which brings about the problem that a stress placed upon the conference participant augments.

### SUMMARY OF THE INVENTION

The present invention has been accomplished in consideration of the controversial points which the above-mentioned prior art bears, and an object thereof is to inexpensively construct a full-duplex telephone conferencing system, in which even though the terminals participating in the telephone conference increase, a throughput at each terminal does not augment and yet only a few data quantity flows within the network, and yet which does not cause a stress placed upon the conference participant to augment, by giving the opportunity of speech to all conference participants without employing a costly specialized apparatus having a remarkably high processing ability.

The multipoint conferencing system of the present invention, which is a multipoint conferencing system for allowing a conference to be held among a plurality of terminals capable of making communication via an IP network, is characterized in including: a telephone conference server for, out of said plurality of said terminals, recognizing the terminal participating in the conference as a terminal belonging to either a speaker group or a listener group, and for generating audio data by making a mixing of audio data from the terminals belonging to said speaker group; and a audio delivering section for delivering the audio data for which a mixing was made by said telephone conference server to terminals belonging to said speaker group and said listener group.

In this case, the telephone conference server may manage opening and ending of the telephone conference, a participation of the terminals in the conference, a withdrawal thereof from the conference, a movement thereof from the speaker group to the listener group, and a movement thereof from the listener group to the speaker group, and may generate the audio data by making a mixing of the audio data of the terminals that currently belong to the speaker group.

Also, the telephone conference server may make selection of a terminal, which moves from the speaker group to the listener group, and selection of a terminal, which moves from the listener group to the speaker group, by combining either of
(1) The number of speech times in an arbitrary time zone
(2) The number of speech times since the conference started
(3) The number of attendance times in the speaker group since the conference started

Also, the terminal belonging to either the speaker group or the listener group may be configured so that a signal from the telephone conference server enables the terminal itself to recognize which group it belongs to, and may comprise a display for showing which group it belongs to.

The configuration method of the multipoint conferencing system of the present invention, which is a configuration method of the multipoint conferencing system for allowing a conference to be held among a plurality of terminals capable of making communication via an IP network, is characterized in that out of said plurality of said terminals, the terminal participating in the conference is recognized as a terminal belonging to either a speaker group or a listener group, and that audio data generated by making a mixing of the audio data from the terminals belonging to said speaker group is delivered to the terminals belonging to said speaker group and said listener group.

In this case, opening and ending of the telephone conference, a participation of the terminals in the conference, a withdrawal thereof from the conference, a movement thereof from the speaker group to the listener group, and a movement thereof from the listener group to the speaker group may be managed, and the audio data may be generated by making a mixing of the audio data of the terminals which currently belong to the speaker group.

Also, selection of a terminal, which moves from the speaker group to the listener group, and selection of a terminal, which moves from the listener group to the speaker group, may be made, by combining either of
(1) The number of speech times in an arbitrary time zone
(2) The number of speech times since the conference started
(3) The number of attendance times in the speaker group since the conference started

Also, the terminal belonging to either the speaker group or the listener group may be configured so that a signal from the telephone conference server enables the terminal itself to recognize which group it belongs to, and may comprise a display for showing which group it belongs to.

The present invention configured as mentioned above takes effect as mentioned below.

(1) A processing load/network load does not augment in proportional to the number of the participating terminals, and only a small processing load/network load is added:

The present invention makes it possible to realize the telephone conferencing system in which even though the terminals participating in the conference increase, a throughput at each terminal does not augment, and yet a data amount flowing within the network also does not augment and only a little data amount flows.

(2) A plurality of the terminals are allowed to make a speech simultaneously in an inexpensive system:

The present invention makes it possible to construct the telephone conferencing system, in which a costly specialized apparatus having a remarkably processing ability is not employed for the multipoint connection server, and many speech audios are not simultaneously and indiscriminately delivered to the terminals that are currently participating in the conference, and yet which allows a plurality of speakers such that the participants can listen to the speech audios of the above speakers to give a call at an identical time.

(3) The full-duplex telephone conferencing system for allowing all conference participants to be given a right to speak:

The present invention makes it possible to inexpensively construct the full-duplex telephone conferencing system for causing a stress placed upon the conference participants not to augment, by giving a right to speak to all conference participants by moving the terminal belonging to the listener group to the speaker group also in a case where the terminal belonging to listener group desires to make a speech.

Also, in the present invention, so as to realize the more inexpensive telephone conferencing system, the participants of the telephone conference are partitioned into the speaker group and the listener group, which are managed respectively. A configuration of the present invention enables a processing load of the server to be suppressed, by putting a limit to the number of the terminals, which are allowed to belong to the speaker group. Putting a limit to the number of the terminals, which are allowed to belong to the speaker group, enables a brainstorming-manner conference form of a many-to-many type, which sometimes encounters a difficulty of listening to the speech contents due to indiscriminately making a mixing of all speeches of the participants, to be avoided, thus giving rise to the merit that construction is made possible of the telephone conferencing system of a few-to-many type, which is more friendly for the listeners.

Further, partitioning the participants of the telephone conference into the speaker group and the listener group for management gives rise to the merit that noise can be deleted that the terminals other than the speaker generate,

### BRIEF DESCRIPTION OF THE DRAWINGS

This and other objects, features and advantages of the present invention will become more apparent upon a reading of the following detailed description and drawings, in which:

FIG. 1 is a block diagram illustrating a configuration of one embodiment of the telephone conferencing system employing the network in according to the present invention;

FIG. 2 is a block diagram illustrating the configuration of the embodiment shown in FIG. 1 in more details;

FIG. 3 is a view illustrating the contents filed in the participant DB 102 to be accommodated in the telephone conference managing section 1 shown in FIG. 2;

FIG. 4 is a view illustrating the contents filed in the listener DB 115 to be accommodated in the listener managing section 4 shown in FIG. 2;

FIG. 5 a view illustrating the contents filed in the multicast group DB 111 to be accommodated in the audio delivering sever 108 shown in FIG. 2;

FIG. 6 is a sequence diagram illustrating an operation of opening the telephone conference, which is the embodiment of the present invention;

FIG. 7 is a sequence diagram illustrating an operation of ending the telephone conference, which is the embodiment of the present invention;

FIG. 8 is a flowchart illustrating an operation in a case where the terminal participates in the telephone conference, which is the embodiment of the present invention;

FIG. 9 is a sequence diagram illustrating an operation of participating in the speaker group by the terminal, which is the embodiment of the present invention;

FIG. 10 is a sequence diagram illustrating an operation of withdrawing from the speaker group by the terminal, which is the embodiment of the present invention;

FIG. 11 is a sequence diagram illustrating an operation of participating in the listener group by the terminal, which is the embodiment of the present invention;

FIG. 12 is a sequence diagram illustrating an operation of withdrawing from the listener group by the terminal, which is the embodiment of the present invention;

FIG. 13 is a sequence diagram illustrating an operation of moving from the listener group to the speaker group by the terminal, which is the embodiment of the present invention;

FIG. 14 is a sequence diagram illustrating an operation of moving from the speaker group to the listener by the terminal, which is the embodiment of the present invention;

FIG. 15 is a view illustrating a configuration of a conventional example;

FIG. 16 is a view illustrating a configuration of a conventional example;

FIG. 17 is a view illustrating a configuration of a conventional example;

FIG. 18 is a view illustrating a configuration of a conventional example;

FIG. 19 is a view illustrating a configuration of a conventional example and

FIG. 20 is a view illustrating a configuration of a conventional example.

### DESCRIPTION OF THE EMBODIMENTS

Next, embodiments of the present invention will be explained, by making a reference to the accompanied drawings.

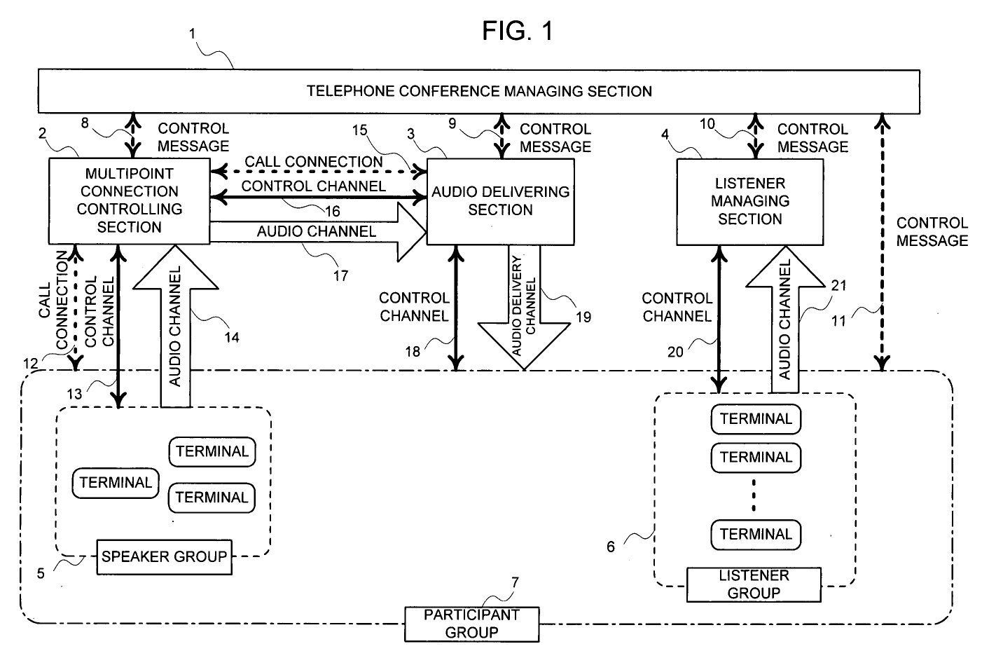

FIG. 1 is a block diagram illustrating a configuration of one embodiment of the telephone conferencing system employing the network.

This embodiment is configured of a telephone conference managing section 1, a multipoint connection controlling section 2, an audio delivering section 3, a listener managing section 4, and a participant group 7.

The participant group 7 is configured of terminals participating in the telephone conference, which are connected to the multipoint connection controlling section 2, the audio delivering section 3, and the listener managing section 4 via an IP network (not shown in the figure), and the terminals are divided into a speaker group 5, which is configured of speaker's terminals that are allowed to make a speech at identical time, and a listener group 6, which is configured of listener's terminals that are in state of only listening to the speech audio data of the speaker's terminal belonging to the above speaker group 5.

The telephone conference managing section 1 manages attribute information such as an IP address of each terminal, and yet takes a control of moving the terminal identified by the listener managing section 4 to be later described from the listener group 6 to the speaker group 5.

The multipoint connection controlling section 2 makes a mixing (synthesis) of the audio data spoken at each terminal participating in the telephone conference, and yet transmits one kind of this audio data for which a mixing was made to the audio delivering section 3.

The audio delivering section 3 delivers the audio data transmitted from the multipoint connection controlling section 2 via an audio channel 17 to all terminals which are currently participating in the telephone conference.

The listener managing section 4 is a means for, out of the terminals belonging to the listener group 6, identifying the terminal, which desires to move to the speaker group 5 for making a speech.

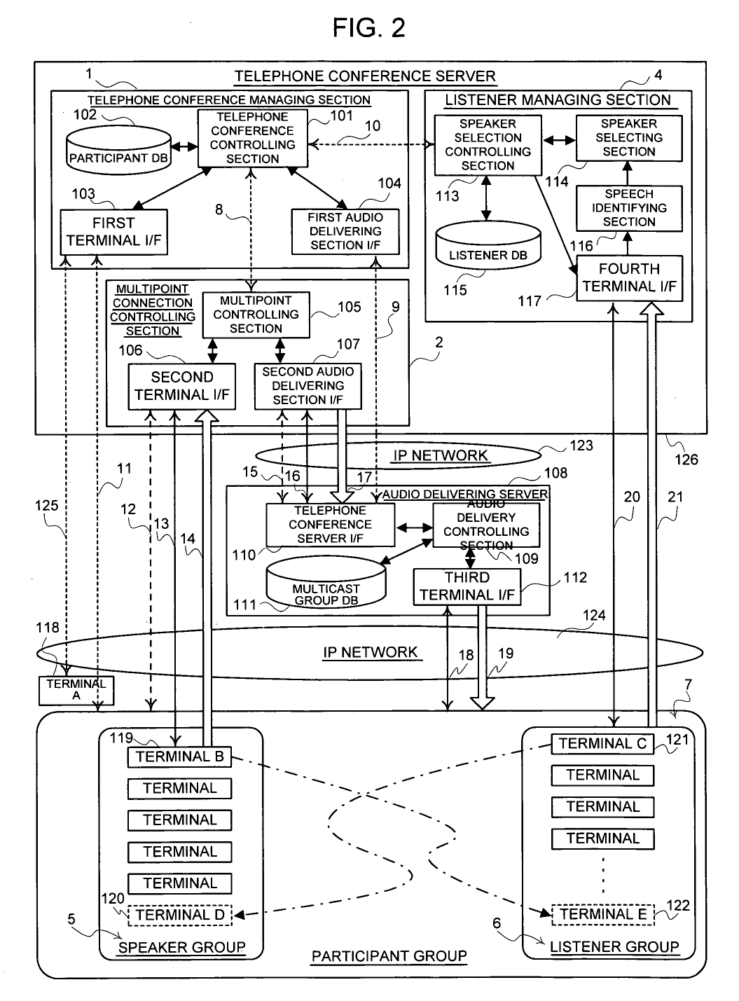

FIG. 2 is a block diagram illustrating the configuration of the embodiment shown in FIG. 1 in more details.

The system shown in FIG. 2 is configured of a telephone conference server 126, the telephone conference managing section 1, the multipoint connection controlling section 2 and the listener managing section 4, which the above telephone conference server 126 has, an audio delivering server 108, the speaker group 5 and the listener group 6, which are configured of the terminals in a mass respectively, the participant group 7, which is configured of the speaker group 5 and the listener group 6, a first control message path 8 for inputting/outputting a control message between the telephone conference managing section 1 and the multipoint connection controlling section 2, a second control message path 9 for transmitting/receiving a control message between the telephone conference managing section 1 and the audio delivering server 108, a third control message path 10 for inputting/outputting a control message between the telephone conference managing section 1 and the listener managing section 4, a fourth control message path 11 for transmitting/receiving a control message between the telephone conference managing section 1 and each of all terminals belonging to the participant group 7, a first call connection 12 to be established for a connection of a call between the multipoint connection controlling section 2 and each of all terminals belonging to the participant group 7, a first control channel 13 in which a connection is logically established for a control between the multipoint connection controlling section 2 and each of all terminals belonging to the speaker group 5, a first audio channel 14 in which a connection is logically established for audio communication between the multipoint connection controlling section 2 and each of all terminals belonging to the speaker group 5, a second call connection 15 to be established for a connection of a call between the multipoint connection controlling section 2 and the audio delivering server 108, a second control channel 16 in which a connection is logically established for a control between the multipoint connection controlling section 2 and the audio delivering server 108, a second audio channel 17 in which a connection is logically established for audio communication between the multipoint connection controlling section 2 and the audio delivering server 108, a third control channel 18 in which a connection is logically established for a control between the audio delivering server 108 and each of all terminals belonging to the participant group 7, a audio delivery channel 19 in which a connection is logically established for audio communication between the audio delivering server 108 and each of all terminals belonging to the participant group 7, a fourth control channel 20 in which a connection is logically established for a control between the listener managing section 4 and each of all terminals belonging to the listener group 6, a third audio channel 21 in which a connection is logically established for audio communication between the listener managing section 4 and each of all terminals belonging to the listener group 6, a first IP network 123, a second IP network 124, a terminal A 118 requesting to open the telephone conference or to participate in the telephone conference, and a fifth control message path 125 for transmitting/receiving a control message between the telephone conference managing section 1 and the terminal A 118.

In FIG. 2, the telephone conference server 126 is configured to have the telephone conference managing section 1, the multipoint connection controlling section 2, and the listener managing section 4; however this is only one example. As the case may be, the telephone conference managing section 1, the multipoint connection controlling section 2, and the listener managing section 4, which need not necessarily to be components of the telephone conference server 126, exist and function outside the telephone conference server 126. Also, in FIG. 2, the function of the audio delivering server 108, which exists outside the telephone conference server 126, exists within the telephone conference server 126 in some cases.

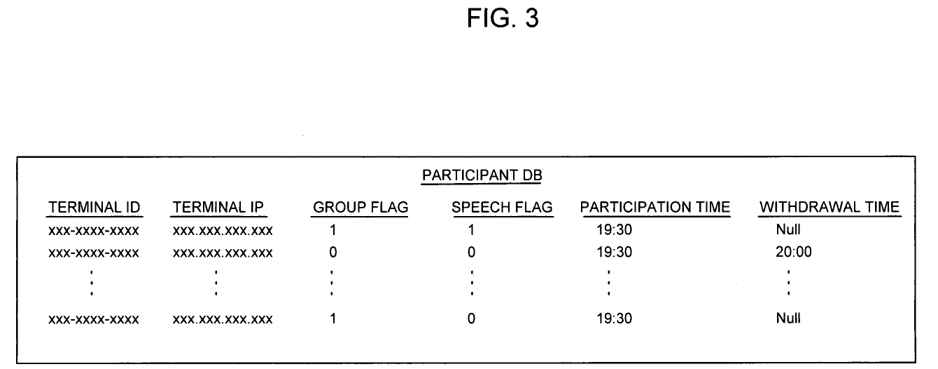

Each of FIG. 3 and FIG. 5 is a view illustrating contents, which are filed in a participant database (hereinafter, a “database” is referred to as a “DB”.) 102 to be accommodated in the telephone conference managing section 1, a listener DB 115 to be accommodated in the listener managing section 4, and a multicast group DB 111 to be accommodated in the audio delivering server 108, and each section of the foregoing basic configuration will be explained below in details, by employing FIG. 2 or FIG. 5.

The telephone conference managing section 1 is configured of a telephone conference managing section 101 for supervising and controlling the telephone conference, the participant DB 102 for filing attribute information such as IP addresses of all terminals participating in the telephone conference, a first terminal I/F 103, being a communication interface (hereinafter, an “interface” is referred to as an “I/F”.) with all terminals participating in the telephone conference, and a first audio delivering section I/F 104, being a communication I/F with the audio delivering server 108.

The multipoint connection controlling section 2 controls a call connection between each of all terminals participating in the telephone conference and the audio delivering server 108, and a control channel and a audio channel between each of all terminals belonging to the speaker group 5 and the audio delivering server 108, yet makes a mixing (synthesis) of the audio data, which was spoken at all terminals belonging to the speaker group 5 and was input via the first audio channel 14 and the second terminal I/F 106, and yet is configured of a multipoint controlling section 105, which transmits this audio data for which a mixing was made to the audio delivering server 108 via a second audio delivering section I/F 107 and the second audio channel 17, a second terminal I/F 106 for making communication with the terminal via the first call connection 12, the first control channel 13 and first audio channel 14, and the second audio delivering section I/F 107 for making communication with the audio delivering server 108 via the second call connection 15, the second control channel 16 and the second audio channel 17.

The audio delivering server 108 is configured of a audio delivery controlling section 109 for controlling a audio delivery of the audio data, which was transmitted from the multipoint connection controlling section 2 and was received via a telephone conference server I/F 110, to all terminals belonging to the participant group 7, the telephone conference server I/F 110, being a communication I/F with the telephone conference server 126, the multicast group DB 111 for filing a single multicast IP address for making a multicast delivery to all terminals belonging to the participant group 7, and a third terminal I/F 112, being a communication I/F with all terminals belonging to the participant group 7.

Also, the listener managing section 4 is configured of a fourth terminal I/F 117, being a communication I/F with all terminals belonging to the listener group 6, a speech identifying section 116 for identifying the speech from the terminal belonging to the listener group 6 as a speech, which was received as a audio packet via the third audio channel 21 and the fourth terminal I/F 117, a speaker selecting section 114 for, out of a plurality of the terminals identified by the speech identifying section 116 as terminals which made a speech, selecting the terminal, which is caused to move from the listener group 6 to the speaker group 5, a listener DB 115 for filing attribute information such as IP addresses of all terminals belonging to the listener group 6, and a speaker selection controlling section 113, which supervises and controls the listener managing section 4 and yet serves as an I/F with the telephone conference managing section 1 as well.

The speaker group 5 is configured of the terminals such as a terminal B 119 and a terminal D 120, which participate in the telephone conference and yet transmit the audio packet to the multipoint connection controlling section 2 via the first audio channel 14 to be logically connected to the multipoint connection controlling section 2.

The listener group 6 is configured of the terminals such as a terminal C 121 and a terminal E 122, which participate in the telephone conference and yet transmit the audio packet to the listener managing section 4 via the third audio channel 21 to be logically connected to the listener managing section 4.

In the participant DB 102 are filed, as shown in FIG. 3, attribution information of all terminals belonging to the participant group 7, a terminal ID such as a telephone number, which is affixed to the terminal in a one-to-one manner, a terminal IP, being an IP address of the terminal, a group flag, which becomes “1” in a case where the group to which the above terminal belongs is the speaker group 5, and becomes “0” in a case where the group to which the above terminal belongs is the listener group 6, a speech flag, which becomes “1” with the terminal, which is currently making a speech, out of the terminals belonging to the speaker group 5, and becomes “0” with the terminal, which is not currently making a speech, and data of the participation time/withdrawal time in/from the telephone conference (in a case where the terminal has not withdrawn from the conference, it becomes NULL.).

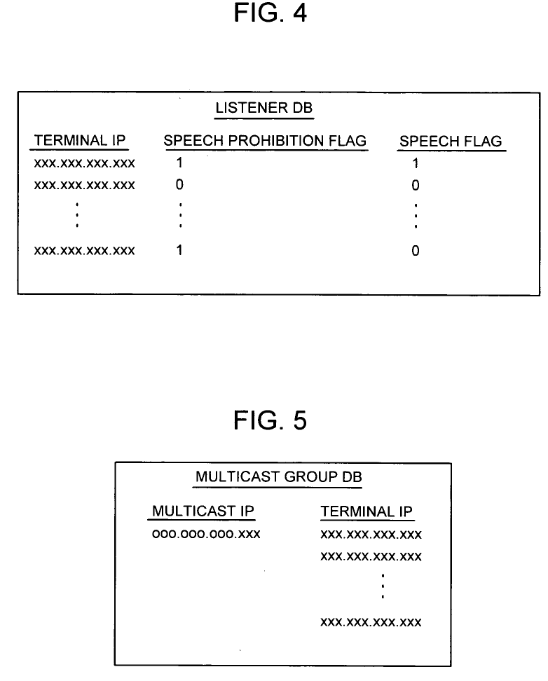

In the listener DB 115 are filed, for example, as shown in FIG. 4, attribution information and terminal IPs of all terminals belonging to the listener group 6, and data of a speech flag, which becomes “1” with the terminal requesting to make a speech, out of the terminals belonging to the listener group 6, and a speech prohibition flag, which assumes “1” with the terminal which is prohibited from making a speech, and assumes “0” with the terminal which is allowed to make a speech, out of the terminals belonging to the listener group 6.

In the multicast DB 111 are filed, as shown in FIG. 5, the IP addresses of the terminals belonging to the participant group, and a single multicast IP address for making a multicast delivery to all of the above terminals.

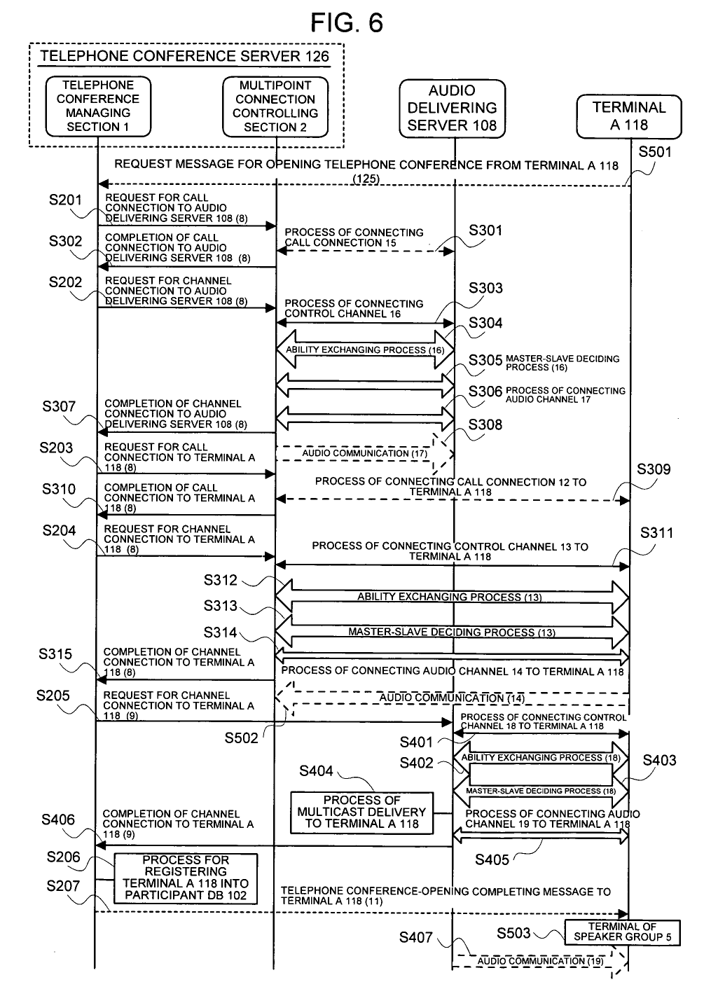

FIG. 6 to FIG. 14 are sequence diagrams illustrating an operation of this embodiment, and the operation of this embodiment will be explained below, by making a reference to FIG. 6 to FIG. 14.

Additionally, the number in a parenthesis of the ending of the word of each step in FIG. 6 to FIG. 14, which is a number for showing which path and logical-channel are used for its step S, shows the path and logical-channel number in FIG. 2.

[Operation of Opening the Telephone Conference]

At first, an operation in opening the telephone conference will be explained, by making a reference to FIG. 6 that is its sequence diagram.

Firstly, the terminal A 118, being a promoter of the telephone conference, transmits a request message for opening the telephone conference to the telephone conference managing section 1 via the fifth control message path 125 (step S501).

When the telephone conference managing section 1 receives the request message for opening the telephone conference from the terminal A 118, it outputs a call connection request massage for requesting a call connection to the audio delivering server 108 to the multipoint connection controlling section 2 via the first control message path 8 (step S201).

When the multipoint connection controlling section 2 inputs the request massage for a call connection to the audio delivering server 108 from the telephone conference managing section 1, it performs a process of connecting a call connection to the audio delivering server 108, and establishes the second call connection 15 (step S301), and when a connecting process of the above call connection is completed, the multipoint connection controlling section 2 outputs a call connection completion message to the telephone conference managing section 1 via the first control message path 8 (step S302).

Next, the telephone conference managing section 1 outputs a logical-channel connection request message for requesting a connection of the logical-channel to the audio delivering server 108 to the multipoint connection controlling section 2 via the first control message path 8 (step S202).

When the multipoint connection controlling section 2 inputs the request message for connecting a logical-channel to the audio delivering server 108 from the telephone conference managing section 1, it performs a process of connecting the second control channel 16 to the audio delivering server 108, and establishes a connection of the second control channel 16 logically (step S303).

Next, the multipoint connection controlling section 2 and the audio delivering server 108 perform the following process via the second control channel 16, i.e. the process of mutually exchanging mutual ability information, that is, ability information required for making audio communication such as, for example, a communication speed, a audio compression method, and existence of a microphone or a loudspeaker (hereafter, the above process is referred to as an “ability exchanging process”.) (step S304).

Next, the multipoint connection controlling section 2 performs a master-slave deciding process of, with the audio delivering server 108, deciding that the multipoint connection controlling section 2 has a leadership in taking a control via the second control channel 16 (step S305).

Next, the multipoint connection controlling section 2 performs a process of connecting the second audio channel 17 to the audio delivering server 108, and establishes a connection of the second audio channel 17 logically (step S306), and when this connecting process of the second audio channel 17 is completed, the multipoint connection controlling section 2 outputs a logical-channel connection completion message indicating that a logical connection of the logical channel to the audio delivering server 108 was completed to the telephone conference managing section 1 via the first control message path 8 (step S307), and transmits the audio packet for which a mixing was made to the audio delivering server 108 via the second audio channel 17 (step S308).

Next, the telephone conference managing section 1 outputs a call connection request message for requesting a call connection to the terminal A 118 to the multipoint connection controlling section 2 via the first control message path 8 (step S203).

When the multipoint connection controlling section 2 inputs the request message for a call connection to the terminal A 118 from the telephone conference managing section 1, it performs a process of connecting a call connection to the terminal A 118, and establishes the first call connection 12 (step S309), and when the above connecting process of the call connection is completed, the multipoint connection controlling section 2 outputs a call connection completion message to the telephone conference managing section 1 via the first control message path 8 (step S310).

Next, the telephone conference managing section 1 outputs a logical-channel connection request message for requesting a connection of the logical channel to the terminal A 118 to the multipoint connection controlling section 2 via the first control message path 8 (step S204).

When the multipoint connection controlling section 2 inputs the request message for connecting a logical channel to the terminal A 118 from the telephone conference managing section 1, it performs a process of connecting the first control channel 13 to the terminal A 118, and establishes a connection of the first control channel 13 logically (step S311).

Next, the multipoint connection controlling section 2 and the terminal A 118 perform an ability exchanging process via the first control channel 13 (step S312).

Next, the multipoint connection controlling section 2 performs a master-slave deciding process of, with the terminal A 118, deciding that the multipoint connection controlling section 2 has a leadership in taking a control via the first control channel 13 (step S313).

Next, the multipoint connection controlling section 2 performs a process of connecting the first audio channel 14 to the terminal A 118, and establishes a connection of the first audio channel 14 logically (step S314), and when this connecting process of the first audio channel 14 is completed, the multipoint connection controlling section 2 outputs a logical-channel connection completion message indicating that a logical connection of the logical channel to the terminal A 118 was completed to the telephone conference managing section 1 via the first control message path 8 (step S315), and receives the audio packet coming from the terminal A 118 via the first audio channel 14 (step S502).

Next, the telephone conference managing section 1 transmits a logical-channel connection request message for requesting a connection of the logical channel to the terminal A 118 to the audio delivering server 108 via the second control message path 9 (step S205).

When the audio delivering server 108 inputs the request message for connecting the logical-channel to the terminal A 118 from the telephone conference managing section 1, it performs a process of connecting the third control channel 18 to the terminal A 118, and establishes a connection of the third control channel 18 logically (step S401).

Next, the audio delivering server 108 and the terminal A 118 perform an ability exchanging process mutually via the third control channel 18 (step S402).

Next, the audio delivering server 108 performs a master-slave deciding process of, with the terminal A 118, deciding that the audio delivering server 108 has a leadership in taking a control via the third control channel 18 (step S403).

Next, the audio delivering server 108 registers the IP address of the terminal A 118 into the multicast group DB 111, and performs the following process, i.e. the process for making a multicast delivery of the audio packet received from the multipoint connection controlling section 2 to the terminal that is decided in a one-to-one manner with the terminal IP filed in the multicast group DB 111, using the multicast IP address filed in the multicast group DB 111 (hereafter, the above process is referred to as a “multicast delivering process”.) (step S404).

Next, the audio delivering server 108 performs a process of connecting the audio delivery channel 19 to the terminal A 118, and establishes a connection of the audio delivery channel 19 logically (step S405), and when this connecting process of the audio delivery channel 19 is completed, the audio delivering server 108 transmits a logical-channel connection completion message indicating that a logical connection of the logical channel to the terminal A 118 was completed to the telephone conference managing section 1 via the second control message path 9 (step S406).

Next, when the telephone conference managing section 1 receives the logical-channel connection completion message indicating that a logical connection of the logical channel to the terminal A 118 was completed from the audio delivering server 108, it registers attribute information such as the IP address of the terminal A 118 into the participant DB 102 (step S206), and transmits a telephone conference-opening completion message indicating that a process of opening the telephone conference was completed to the terminal A 118 via the fourth control message path 11 (step S207), and thereby, the terminal A 118 becomes a terminal belonging to the speaker group 5 (step S503), and receives the audio packet coming from the audio delivering server 108 via the audio delivery channel 19 (step S407).

By the sequence above, opening of the telephone conference is realized, based upon the telephone conference-opening request by the terminal A 118.

[Explanation of an Operation of Ending the Telephone Conference]

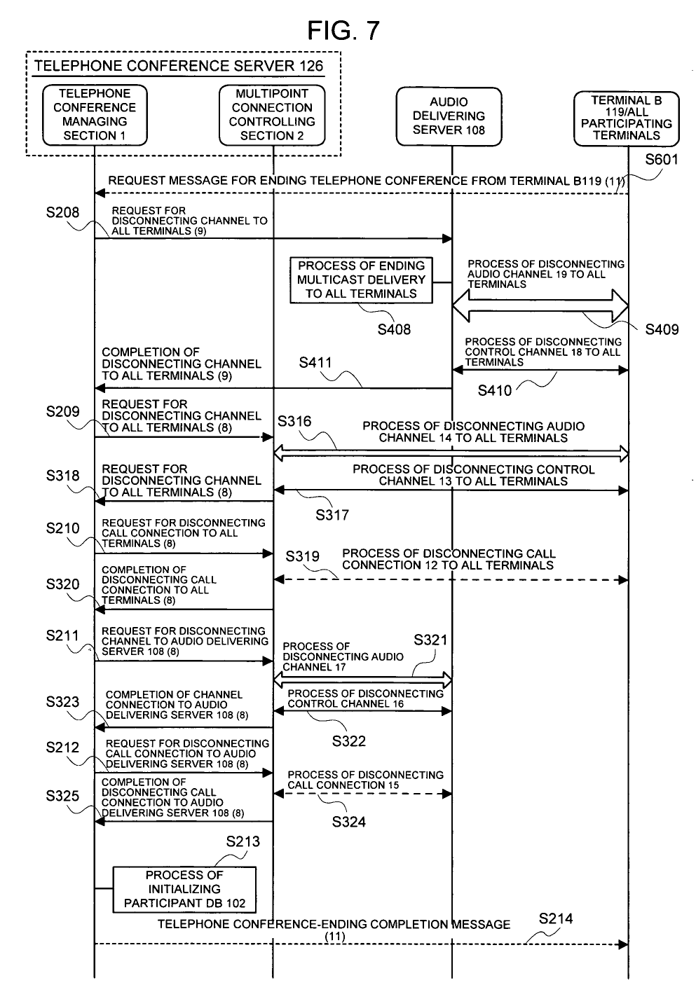

Next, an operation of ending the telephone conference will be explained, by making a reference to FIG. 7 that is its sequence diagram.

Firstly, the terminal B 119, being a promoter of the telephone conference, transmits a request message for ending the telephone conference to the telephone conference managing section 1 via the fourth control message path 11 (step S601).

Next, the telephone conference managing section 1 transmits a logical-channel disconnection request message for requesting a disconnection of the logical channel to all terminals belonging to the participant group 7 to the audio delivering server 108 via the second control message path 9 (step S208).

Next, the audio delivering server 108 deletes the IP addresses of all terminals belonging to the participant group 7 from the multicast group DB 111, and performs the following process, i.e. the process of ending a multicast delivery of the audio packet received from the multipoint connection controlling section 2 to the terminal that is decided in a one-to-one manner with the terminal IP filed in the multicast group DB111, using the multicast IP address filed in the multicast group DB 111 (hereafter, the above process is referred to as a “multicast delivery ending process”.) (step S408).

Next, the audio delivering server 108 performs a process of disconnecting the audio delivery channel 19 to all terminals belonging to the participant group 7 (step S409).

Next, the audio delivering server 108 performs a process of disconnecting the third control channel 18 to all terminals belonging to the participant group 7 (step S410), and after the above disconnecting process is completed, the audio delivering server 108 transmits a logical-channel disconnection completion message indicating that a disconnection was completed of the logical channel between the audio delivering server 108 and each of all terminals belonging to the participant group 7 to the telephone conference managing section 1 via the second control message path 9 (step S411).

Next, the telephone conference managing section 1 outputs a logical-channel disconnection request message for requesting a disconnection of the logical-channel to all terminals belonging to the participant group 7 to the multipoint connection controlling section 2 via the first control message path 8 (step S209).

Next, the multipoint connection controlling section 2 performs a process of disconnecting the first audio channel 14 to all terminals belonging to the speaker group (step S316).

Next, the multipoint connection controlling section 2 performs a process of disconnecting the first control channel 13 to all terminals belonging to the speaker group 5 (step S317).

Next, the multipoint connection controlling section 2 outputs a logical-channel disconnection completion message indicating that a disconnection was completed of the logical channel to all terminals belonging to the speaker group 5 to the telephone conference managing section 1 via the first control message path 8 (step S318).

Next, the telephone conference managing section 1 outputs a call-connection disconnection message for requesting a disconnection of the call connection to all terminals belonging to the participant group 7 to the multipoint connection controlling section 2 via the first control message path 8 (step S210).

Next, when the multipoint connection controlling section 2 inputs the requesting massage for a disconnection of the call connection to all terminals belonging to the participant group 7 from the telephone conference managing section 1, it performs a process of disconnecting the first call connection 12 to all terminals belonging to the participant group 7 (step S319), and when the above disconnecting process of the call connection is completed, the multipoint connection controlling section 2 outputs a call-connection disconnection completion message to the telephone conference managing section 1 via the first control message path 8 (step S320).

Next, the telephone conference managing section 1 outputs a logical-channel disconnection request message for requesting a disconnection of the logical-channel to the audio delivering server 108 to the multipoint connection controlling section 2 via the first control message path 8 (step S211).

Next, when the multipoint connection controlling section 2 inputs the above logical-channel disconnection request message from the telephone conference managing section 1, it performs a process of disconnecting the second audio channel 17 (step S321), thereafter, the multipoint connection controlling section 2 performs a process of disconnecting the second control channel 16 (step S322), and when the above disconnecting process was completed, the multipoint connection controlling section 2 outputs a logical-channel disconnection completion message indicating that a disconnection of the logical-channel to the audio delivering server 108 was completed to the telephone conference managing section 1 via the first control message path 8 (step S323).

Next, the telephone conference managing section 1 outputs a call-connection disconnection request message for requesting a disconnection of the call connection to the audio delivering server 108 to the multipoint connection controlling section 2 via the first control message path 8 (step S212), and when the multipoint connection controlling section 2 inputs the above call-connection disconnection request message from the telephone conference managing section 1, it performs a process of disconnecting the second call connection 15 to the audio delivering server 108 (step S324).

Next, when a disconnection is completed of the second call connection 15 to the audio delivering server 108, the multipoint connection controlling section 2 outputs a call-connection disconnection completion message indicating that a disconnection of the call connection to the audio delivering server 108 was completed to the telephone conference managing section 1 via the first control message path 8 (step S325).

Next, the telephone conference managing section 1 performs an initializing process of wholly deleting information of the participating terminals of the participant DB 102 (step S213).

Next, the telephone conference managing section 1 transmits a telephone conference-ending completion message indicating that a process of ending the telephone conference was completed to the terminal B 119 via the fourth control message path 11 (step S214).

By the sequence above, ending of the telephone conference is realized, based upon the telephone conference-ending request by the terminal B 119.

[Explanation of an Operation of Participating in the Telephone Conference by the Terminal]

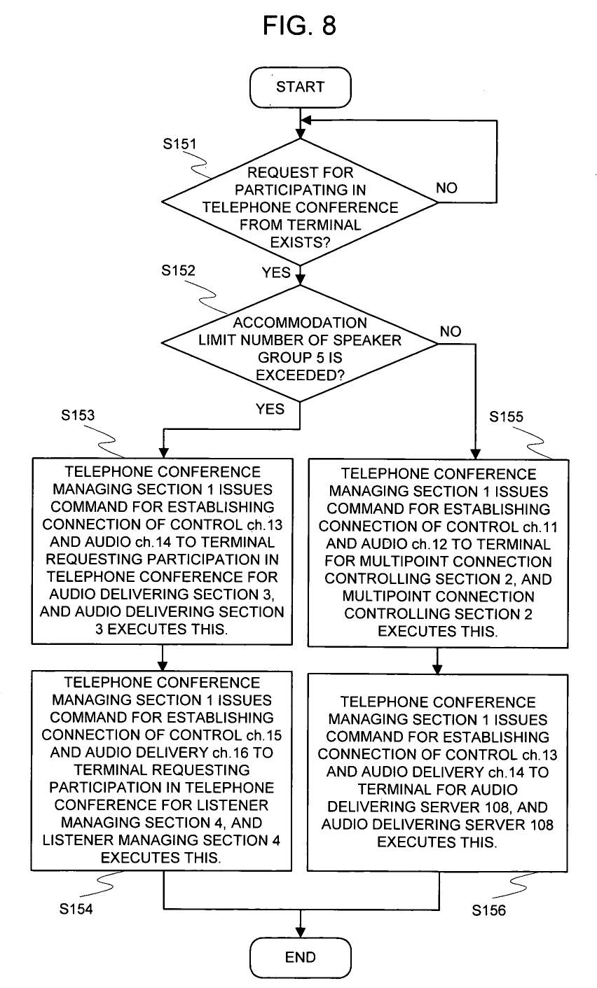

Next, an operation will be explained of a case where the terminal participates in the telephone conference, by making a reference to FIG. 8 that is its flowchart.

When the telephone conference managing section 1 confirms existence of a request for participating in the telephone conference by the terminal (step S151), and receives a request for participating in the telephone conference from the terminal, it confirms whether a predetermined limit to the speaker number of the speaker group 5 is exceeded (step S152).

In the step S152, in a case where it was confirmed that a predetermined limit to the speaker number of the speaker group 5 was not exceeded, the telephone conference managing section 1 issues a command for making a connection to the above terminal for the multipoint connection controlling section 2 and the audio delivering server 108, and establishes a connection between the multipoint connection controlling section 2 and the above terminal, and a connection between the audio delivering section 3 and the above terminal respectively (step S155 and step S156). In the step 152, in a case where it was confirmed that a predetermined limit to the speaker number of the speaker group 5 would be exceeded, by participating in the telephone conference by the terminal which issued a request for newly participating in the telephone conference, the telephone conference managing section 1 issues a command for making a connection to the above terminal for the audio delivering section 3 and the listener managing section 4, and establishes a connection between the audio delivering section 3 and the above terminal, and a connection between the listener managing section 4 and the above terminal respectively (step S153 and step S154).

[Explanation of an Operation of Participating in the Speaker Group 5 by the Terminal]

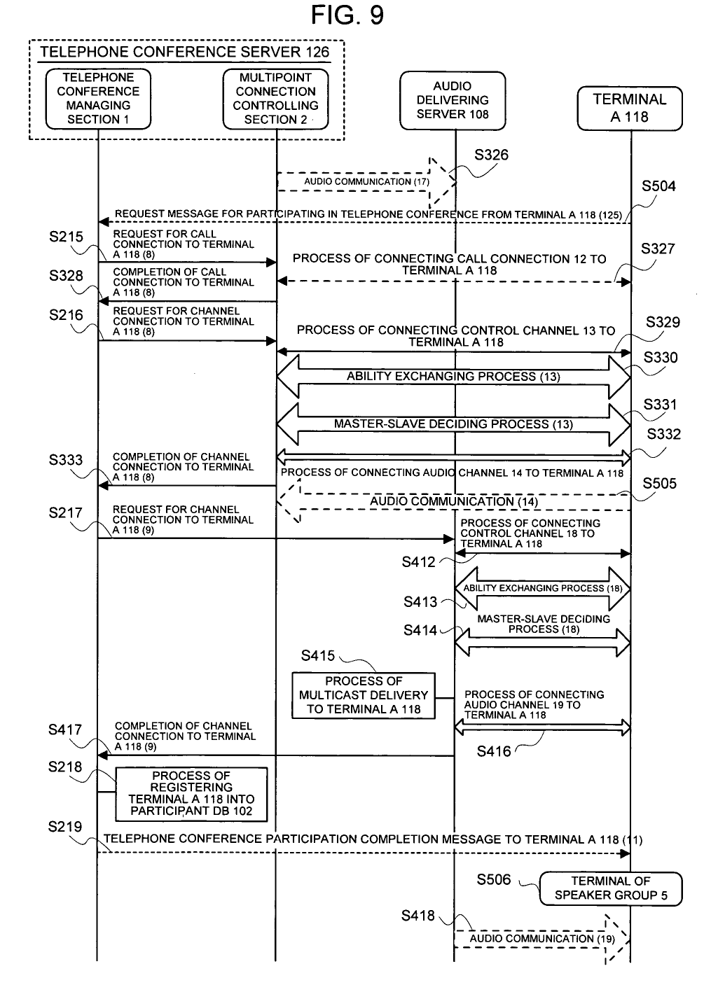

Next, an operation will be explained of a case where the terminal participates in the speaker group 5, by making a reference to FIG. 9 that is its sequence diagram.

The telephone conference has been already opened, so audio communication is currently being made from the multipoint connection controlling section 2 to the audio delivering server 108 via the second audio channel 17 (step S326).

The terminal A 118 transmits a telephone conference participation request message to the telephone conference managing section 1 via the fifth control message path 125 (step S504).

Next, the telephone conference managing section 1 outputs a call connection request message for requesting a call connection to the terminal A 118 to the multipoint connection controlling section 2 via the first control message path 8 (step S215).

When the multipoint connection controlling section 2 inputs the request message for a call connection to the terminal A 118 from the telephone conference managing section 1, it performs a process of connecting a call connection to the terminal A 118, and establishes the first call connection 12 (step S327), and when the above connecting process of the call connection is completed, the multipoint connection controlling section 2 outputs a call connection completion message to the telephone conference managing section 1 via the first control message path 8 (step S328).

Next, the telephone conference managing section 1 outputs a logical-channel connection request message for requesting a connection of the logical channel to the terminal A 118 to the multipoint connection controlling section 2 via the first control message path 8 (step S216).

When the multipoint connection controlling section 2 inputs the request message for connecting the logical channel to the terminal A 118 from the telephone conference managing section 1, it performs a process of connecting the first control channel 13 to the terminal A 118, and establishes a connection of the first control channel 13 logically (step S329).

Next, the multipoint connection controlling section 2 and the terminal A 118 perform an ability exchanging process mutually via the first control channel 13 (step S330).

Next, the multipoint connection controlling section 2 performs a master-slave deciding process of, with the terminal A 118, deciding that the multipoint connection controlling section 2 has a leadership in taking a control via the first control channel 13 (step S331).

Next, the multipoint connection controlling section 2 performs a process of connecting the first audio channel 14 to the terminal A 118, and establishes a connection of the first audio channel 14 logically (step S332). When this connecting process of the first audio channel 14 is completed, the multipoint connection controlling section 2 outputs a logical-channel connection completion message indicating that a logical connection of the logical-channel to the terminal A 118 was completed to the telephone conference managing section 1 via the first control message path 8 (step S333), and receives the audio packet coming from the terminal A 118 via the first audio channel 14 (step S505).

Next, the telephone conference managing section 1 transmits a logical-channel connection request message for requesting a connection of the logical channel to the terminal A 118 to the audio delivering server 108 via the second control message path 9 (step S217).

When the audio delivering server 108 inputs the request message for connecting the logical-channel to the terminal A 118 from the telephone conference managing section 1, it performs a process of connecting the third control channel 18 to the terminal A 118, and establishes a connection of the third control channel 18 logically (step S412).

Next, the audio delivering server 108 and the terminal A 118 perform an ability exchanging process mutually via the third control channel 18 (step S413).

Next, the audio delivering server 108 registers the IP address of the terminal A 118 into the multicast group DB 111, and performs a master-slave deciding process of, with the terminal A 118, deciding that the audio delivering server 108 has a leadership in taking a control via the third control channel 18 (step S414).

Next, the audio delivering server 108 registers the IP address of the terminal A 118 into the multicast group DB 111, and performs a multicast delivering process (step S415).

Next, the audio delivering server 108 performs a process of connecting the audio delivery channel 19 to the terminal A 118, and establishes a connection of the audio delivery channel 19 logically (step S416), and when this connecting process of the audio delivery channel 19 is completed, the audio delivering server 108 transmits a logical-channel connection completion message indicating that a logical connection of the logical channel to the terminal A 118 was completed to the telephone conference managing section 1 via the second control message path 9 (step S417).

Next, when the telephone conference managing section 1 receives the logical-channel connection completion message indicating that a logical connection of the logical channel to the terminal A 118 was completed from audio delivering server 108, it registers attribute information such as the IP address of the terminal A 118 into the participant DB 102 (step S218), and transmits a telephone conference participation completion message indicating that a process of participating in the telephone conference was completed to the terminal A 118 via the fourth control message path 11 (step S219). Thereby, the terminal A 118 becomes a terminal belonging to the speaker group 5 (step S506), and receives the audio packet coming from the audio delivering server 108 via the audio delivery channel 19 (step S418).

By the sequence above, a participation in the speaker group 5 is realized in the telephone conference, based upon the telephone conference participation request by the terminal A 118.

[Explanation of an Operation of Withdrawing from the Speaker Group 5 by the Terminal]

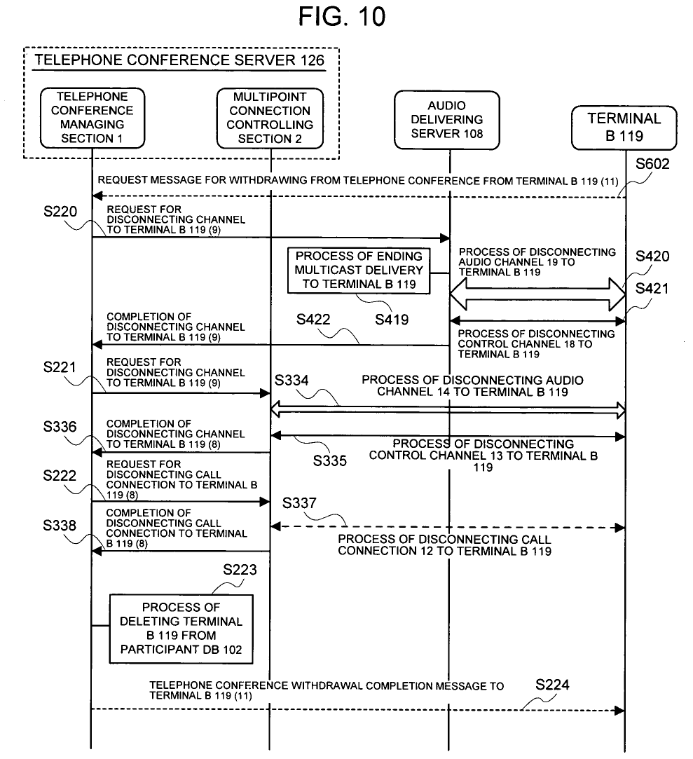

Next, an operation will be explained of a case where the terminal withdraws from the speaker group 5, by making a reference to FIG. 10 that is its flowchart.

At first, the terminal B 119 transmits a request message for withdrawing from the telephone conference to the telephone conference managing section 1 via the fourth control message path 11 (step S602).

Next, the telephone conference managing section 1 transmits a logical-channel disconnection request message for requesting a disconnection of the logical-channel to the terminal B 119 to the audio delivering server 108 via the second control message path 9 (step S220).

Next, the audio delivering server 108 deletes the IP address of the terminal B 119 from the multicast group DB 111, and performs a multicast delivery ending process. (step S419).

Next, the audio delivering server 108 performs a process of disconnecting the audio delivery channel 19 to the terminal B 119 (step S420).

Next, the audio delivering server 108 performs a process of disconnecting the third control channel 18 to the terminal B 119 (step S421), and after the above disconnecting process is completed, the audio delivering server 108 transmits a logical-channel disconnection completion message indicating that a disconnection was completed of the logical channel between the audio delivering server 108 and the terminal B 119 to the telephone conference managing section 1 via the second control message path 9 (step S422).

Next, the telephone conference managing section 1 outputs a logical-channel disconnection request message for requesting a disconnection of the logical channel to the terminal B 119 to the multipoint connection controlling section 2 via the first control message path 8 (step S221).

Next, the multipoint connection controlling section 2 performs a process of disconnecting the first audio channel 14 to the terminal B 119 (step S334).

Next, the multipoint connection controlling section 2 performs a process of disconnecting the first control channel 13 to the terminal B 119 (step S335).

Next, the multipoint connection controlling section 2 outputs a logical-channel disconnection completion message indicating that a disconnection of the logical channel to the terminal B 119 was completed to the telephone conference managing section 1 via the first control message path 8 (step S336).

Next, the telephone conference managing section 1 outputs a call-connection disconnection request message for requesting a disconnection of the call connection to the terminal B 119 to the multipoint connection controlling section 2 via the first control message path 8 (step S222).

Next, when the multipoint connection controlling section 2 inputs the request message for disconnecting a call connection to the terminal B 119 from the telephone conference managing section 1, it performs a process of disconnecting the first call connection 12 to the terminal B 119 (step S337), and when the disconnecting process of the above call connection is completed, the multipoint connection controlling section 2 outputs a call-connection disconnection completion message to the telephone conference managing section 1 via the first control message path 8 (step S338).

Next, the telephone conference managing section 1 performs a process of deleting information associated with the terminal B 119 in the participant DB 102 (step S223).

Next, the telephone conference managing section 1 transmits a telephone conference withdrawal completion message indicating that a process of withdrawing from the telephone conference was completed to the terminal B 119 via the fourth control message path 11 (step S224).

By the sequence above, the process of withdrawing from the telephone conference is realized, based upon the telephone conference withdrawal request from by the terminal B 119.

[Explanation of an Operation of Participating in the Listener Group 6 by the Terminal]

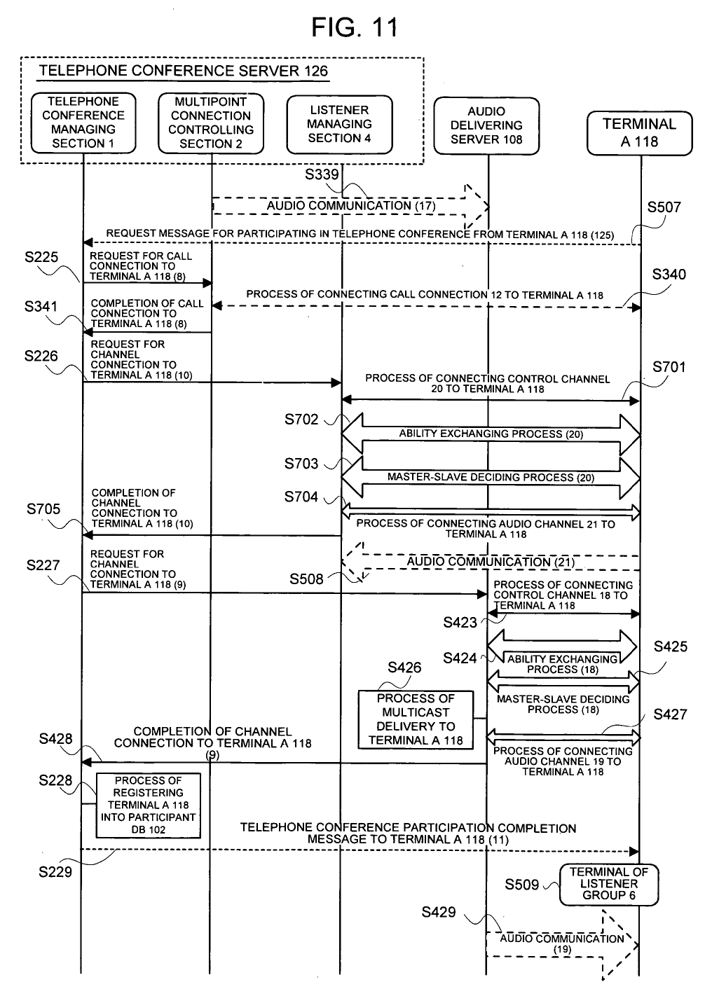

Next, an operation will be explained of a case where the terminal participates in the listener group 6, by making a reference to FIG. 11 that is its sequence diagram.

The telephone conference has been already opened, so audio communication is currently being made from the multipoint connection controlling section 2 to the audio delivering server 108 via the second audio channel 17 (step S339).

The terminal A 118 transmits a telephone conference participation request message to the telephone conference managing section 1 via the fifth control message path 125 (step S507).

Next, the telephone conference managing section 1 outputs a request message for a call connection to the terminal A 118 to the multipoint connection controlling section 2 via the first control message path 8 (step S225).

Next, when the multipoint connection controlling section 2 inputs the request message for a call connection to the terminal A 118 from the telephone conference managing section 1, it performs a process of connecting the first call connection 12 to the terminal A 118 (step S340), and when the above connecting process was completed, the multipoint connection controlling section 2 outputs a call connection completion message to the telephone conference managing section 1 via the first control message path 8 (step S341).

Next, the telephone conference managing section 1 outputs a request for connecting a logical channel to the terminal A 118 to the listener managing section 4 via the third control message path 10 (step S226).

Next, the listener managing section 4 performs a process of connecting the fourth control channel 20 to the terminal A 118 (step S701).

Next, the listener managing section 4 performs a process of mutually exchanging ability with the terminal A 118 via the fourth control channel 20 (step S702).

Next, the listener managing section 4 performs a master-slave deciding process of, with the terminal A 118, deciding that the listener managing section 4 has a leadership in taking a control via the fourth control channel 20 (step S703).

Next, the listener managing section 4 performs a process of connecting the third audio channel 21 to the terminal A 118 (step S704).

Next, when a connection is completed of the logical channel to the terminal A 118, the listener managing section 4 outputs a logical-channel connection completion message to the telephone conference managing section 1 via the third control message path 10 (step S705), and after the above process, the terminal A 118 initiates audio communication to the listener managing section 4 via the third audio channel 21 (step S508).

Next, the telephone conference managing section 1 outputs a message for requesting a connection of a logical channel to the terminal A 118 to the audio delivering server 108 via the second control message path 9 (step S227).

Next, the audio delivering server 108 performs a process of connecting the third control channel 18 to the terminal A 118 (step S423).

Next, the audio delivering server 108 performs a process of mutually exchanging ability with the terminal A 118 via the third control channel 18 (step S424).

Next, the audio delivering server 108 performs a master-slave deciding process of, with the terminal A 118, deciding that the audio delivering server 108 has a leadership in taking a control via the third control channel 18 (step S425).

Next, the audio delivering server 108 registers the IP address of the terminal A 118 into the multicast group DB 111, and performs a multicast delivering process (step S426).

Next, the audio delivering server 108 performs a process of connecting the audio delivery channel 19 to the terminal A 118 (step S427).

Next, when a connection of the logical channel to the terminal A 118 is completed, the audio delivering server 108 outputs a logical-channel connection completion message to the telephone conference managing section 1 via the second control message path 9 (step S428), and after the above process, the telephone conference managing section 1 performs a process of registering information of the terminal A 118 into the participant DB 102 (step S228).

Next, the telephone conference managing section 1 transmits a telephone conference participation completion message to the terminal A 118 via the fourth control message path 11 (step S229). Thereby, the terminal A 118 becomes a terminal belonging to the listener group 6 (step S509).

Next, the audio delivering server 108 initiates an audio delivery to the terminal A 118 via the audio delivery channel 19 (step S429). By the sequence above, the participation in the listener group 6 is realized in the telephone conference, based upon the telephone conference participation request by the terminal A 118.

[Explanation of an Operation of Withdrawing from the Listener Group 6 by the Terminal]

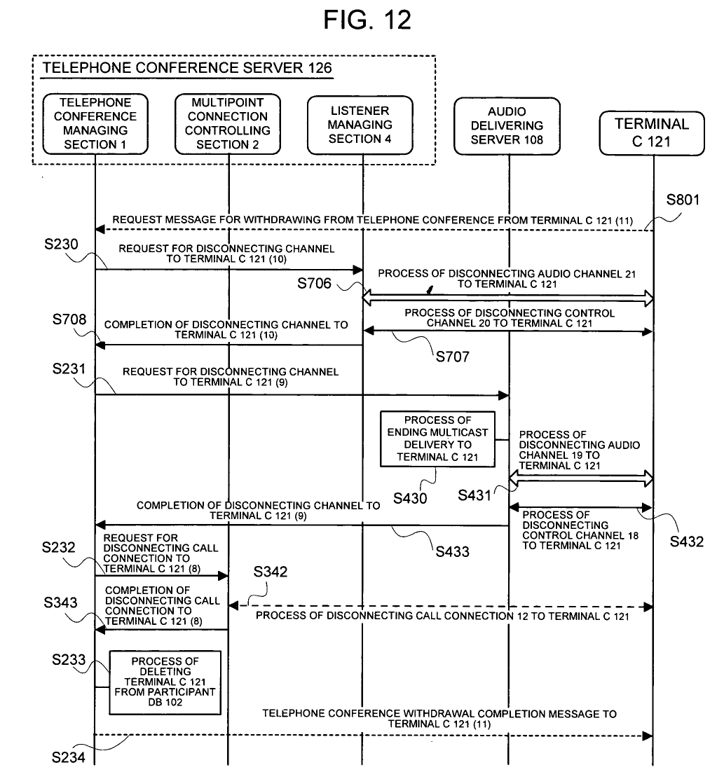

Next, an operation will be explained of a case where the terminal withdraws from the listener group 6, by making a reference to FIG. 12 that is its sequence diagram.

At first, the terminal C 121 transmits a telephone conference withdrawal request message to the telephone conference managing section 1 via the fourth control message path 11 (step S801).

Next, the telephone conference managing section 1 outputs a logical-channel disconnection request message for requesting a disconnection of the logical channel to the terminal C 121 to the listener managing section 4 via the third control message path 10 (step S230).

Next, the listener managing section 4 performs a process of disconnecting the third audio channel 21 to the terminal C 121 (step S706).

Next, the listener managing section 4 performs a process of disconnecting the fourth control channel 20 to the terminal C 121 (step S707).

Next, the listener managing section 4 outputs a logical-channel disconnection completion message indicating that a disconnection of the logical channel to the terminal C 121 was completed to the telephone conference managing section 1 via the third control message path 10 (step S708).

Next, the telephone conference managing section 1 outputs a logical-channel disconnection request message for requesting a disconnection of the logical channel to the terminal C 121 to the audio delivering server 108 via the second control message path 9 (step S231).

Next, the audio delivering server 108 deletes the IP address of the terminal C 121 from the multicast group DB 111, and performs a multicast delivery ending process (step 5430).

Next, the audio delivering server 108 performs a process of disconnecting the audio delivery channel 19 to the terminal C 121 (step S431).

Next, the audio delivering server 108 performs a process of disconnecting the third control channel 18 to the terminal C 121 (step S432), and after the above disconnecting process was completed, the audio delivering server 108 transmits a logical-channel disconnection completion message indicating that a disconnection was completed of the logical channel between the audio delivering server 108 and the terminal C 121 to the telephone conference managing section 1 via the second control message path 9 (step S433).

Next, the telephone conference managing section 1 outputs a call-connection disconnection message for requesting a disconnection of the call connection to the terminal C 121 to the multipoint connection controlling section 2 via the first control message path 8 (step S232).

Next, when the multipoint connection controlling section 2 inputs the message for requesting a disconnection of the call connection to the terminal C 121 from the telephone conference managing section 1, it performs a process of disconnecting the first call connection 12 to the terminal C 121 (step S342), and when the disconnecting process of the above call connection is completed, the multipoint connection controlling section 2 outputs a call-connection disconnection completion message to the telephone conference managing section 1 via the first control message path 8 (step S343).

Next, the telephone conference managing section 1 performs a process of deleting information associated with the terminal C 121 in the participant DB 102 (step S233).

Next, the telephone conference managing section 1 transmits a telephone conference withdrawal completion message indicating that a process of withdrawing from the telephone conference was completed to the terminal C 121 via the fourth control message path 11 (step S234).

By the sequence above, the withdrawal from the telephone conference is realized, based upon the telephone conference withdrawal request by the terminal C 121.

[Explanation of an Operation of Moving from the Listener Group 6 to the Speaker Group 5 by the Terminal]

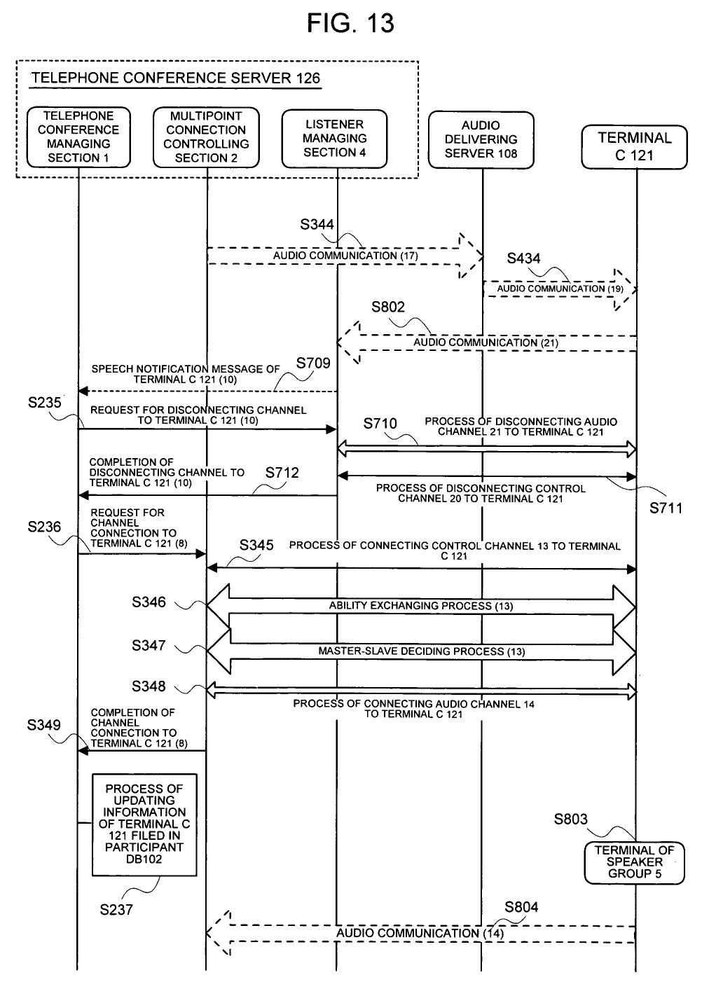

Next, an operation will be explained of a case where the terminal moves from the listener group 6 to the speaker group 5, by making a reference to FIG. 13 that is its sequence diagram.

The telephone conference has been already opened, so audio communication is currently being made from the multipoint connection controlling section 2 to the audio delivering server 108 via the second audio channel 17 (step S344), audio communication is currently being made from the audio delivering server 108 to the terminal C 121 via the audio delivery channel 19 (step S434), and audio communication is currently being made from the terminal C 121 to the listener managing section 4 via the third audio channel 21 (step S802).

A audio packet is transmitted from the terminal C 121 belonging to the listener group 6 to the speech identifying section 116 via the third audio channel 21 and the fourth terminal I/F 117, thereby the speech identifying section 116 receives the above audio packet, and identifies the speech of the terminal C 121, and next the speech identifying section 116, which made the above identification, outputs the fact that the terminal C 121 made a speech to the speaker selecting section 114, the speaker selecting section 114 assumes a speech flag filed in the listener DB 115, which corresponds to the terminal C 121, to be “1”, and yet outputs the terminal IP of the terminal C 121 to the speaker selection controlling section 113 so as to indicate that the terminal C 121 was selected as a speaker after confirming that a speech prohibition flag was not “1”, and the speaker selection controlling section 113 outputs a speech notification message indicating that the terminal C 121 made a speech to the telephone conference managing section 1 via the third control message path 10 (step S709).

Next, when the telephone conference managing section 1 inputs the speech notification message of the terminal C 121 from the listener managing section 4, it outputs a logical-channel disconnection request message for requesting a disconnection of the logical channel to the terminal C 121 to the listener managing section 4 via the third control message path 10 (step S235).

Next, when the listener managing section 4 inputs the logical-channel disconnection request message for requesting a disconnection of the logical channel to the terminal C 121 from the telephone conference managing section 1, it performs a process of disconnecting the third audio channel 21 to the terminal C 121 (step S710), and next performs a process of disconnecting the fourth control channel 20 to the terminal C 121 (step S711).

Next, the listener managing section 4 outputs a logical-channel disconnection completion message indicating that a disconnection of the logical channel to the terminal C 121 was completed to the telephone conference managing section 1 via the third control message path 10 (step S712).

Next, the telephone conference managing section 1 outputs a message for requesting a connection of a logical channel to the terminal C 121 to multipoint connection controlling section 2 via the first control message path 8 (step S236).

Next, when the multipoint connection controlling section 2 inputs the message for requesting a connection of the logical channel to the terminal C 121 from the telephone conference managing section 1, it performs a process of connecting the first control channel 13 to the terminal C 121 (step S345), next performs a process of exchanging ability with the terminal C 121 via the first control channel 13 (step S346), next performs a master-slave deciding process of, with the terminal C 121, deciding that the multipoint connection controlling section 2 has a leadership in taking a control via the first control channel 13 (step S347), next performs a process of connecting the first audio channel 14 to the terminal C 121 (step S348), and next outputs a logical-channel connection completion message indicating that a connection of the logical channel to the terminal C 121 was completed to the telephone conference managing section 1 via the first control message path 8 (step S349).

Next, the telephone conference managing section 1 performs a process of updating information associated with the terminal C 121 filed in the participant DB 102 (step S237). Thereby, the terminal C 121 becomes a terminal belonging to the speaker group 5 (step S803), and the multipoint connection controlling section 2 comes to receive the audio packet, which the above terminal transmits, via the first audio channel 14 (step S804).

By the sequence above, it is realized that the terminal, which belonged to the listener group 6, moves to the speaker group 5.

[Explanation of an Operation of Moving from the Speaker Group 5 to the Listener Group 6 by the Terminal]

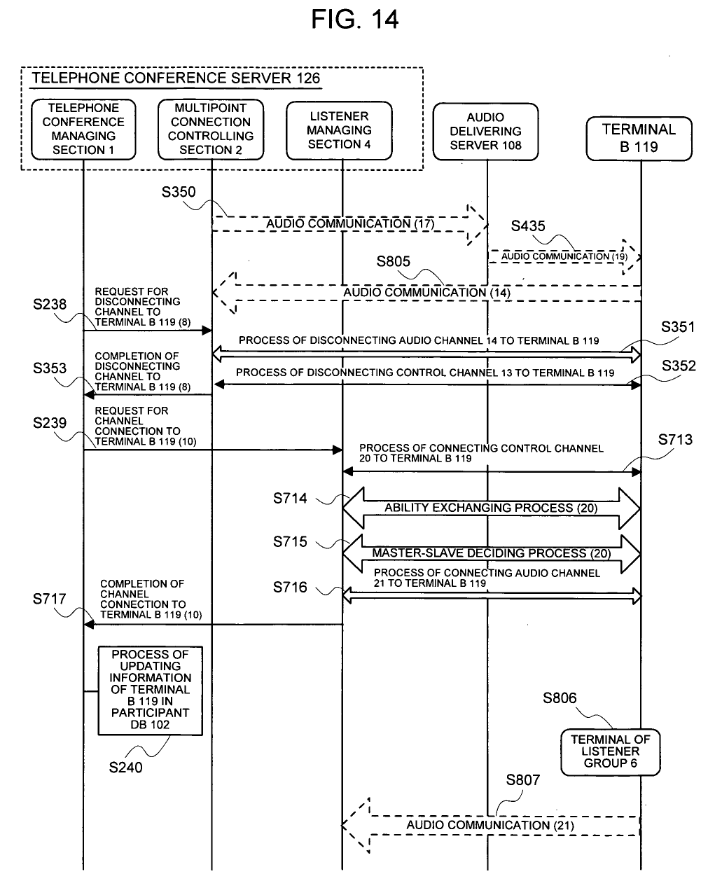

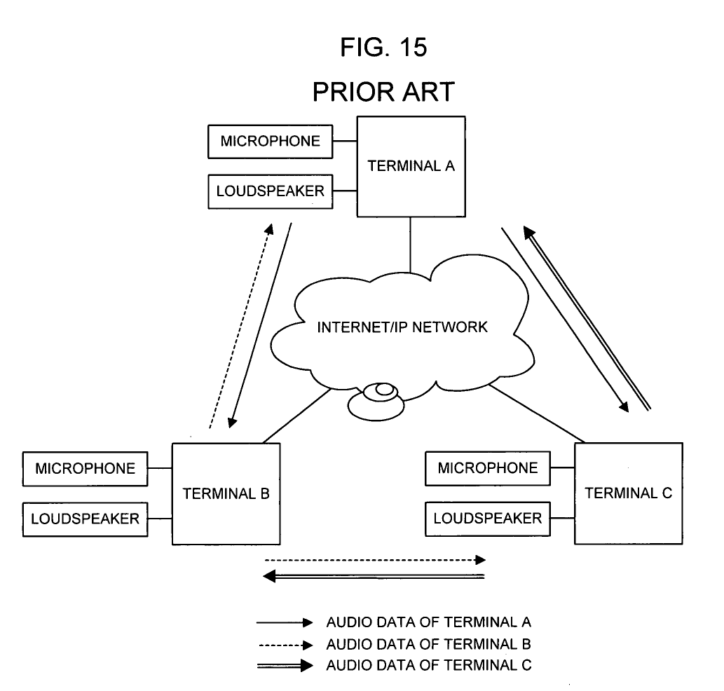

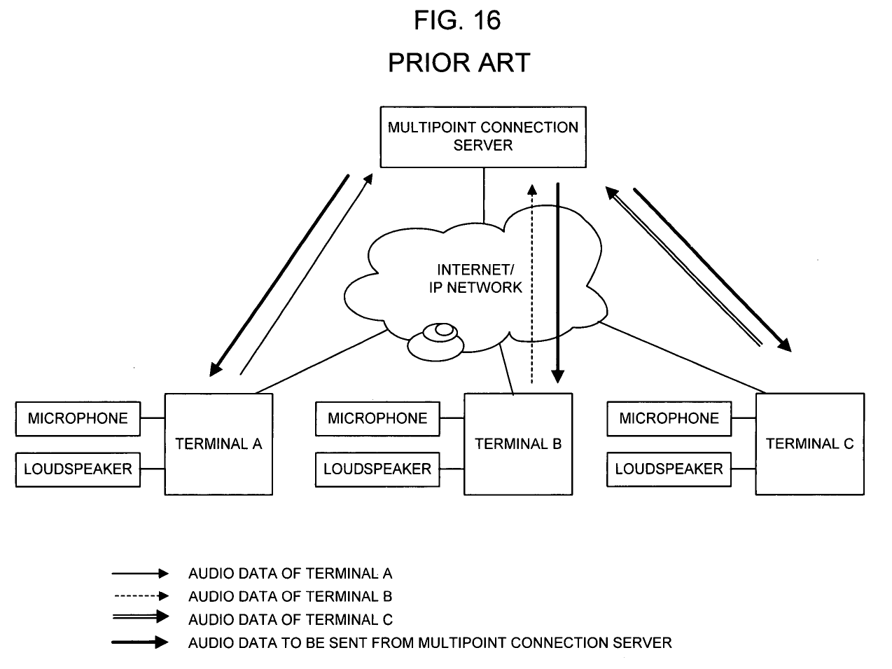

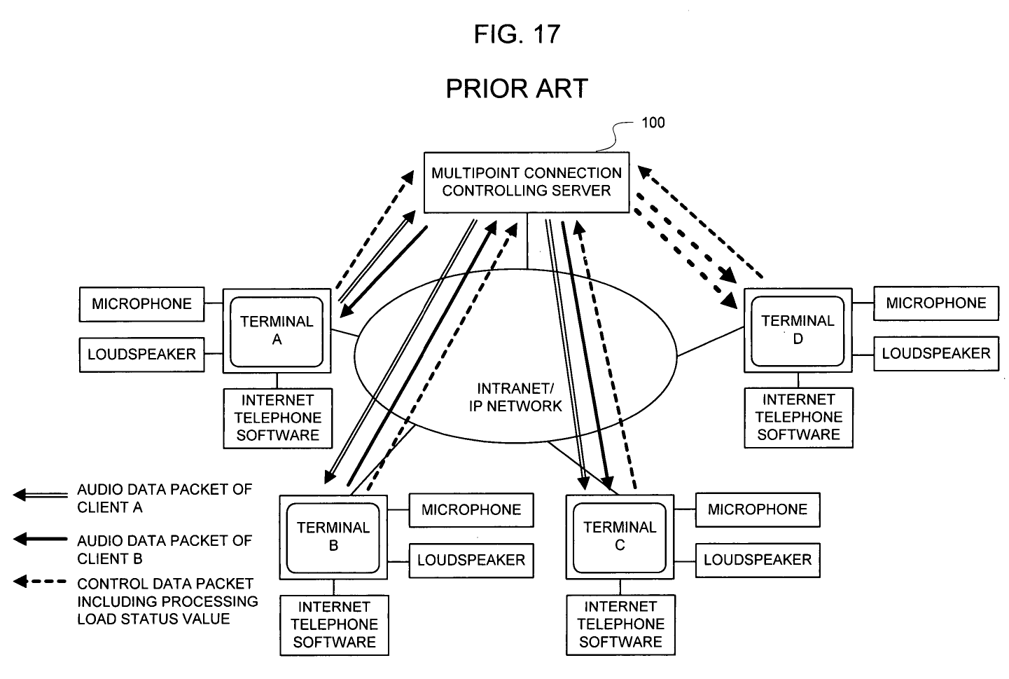

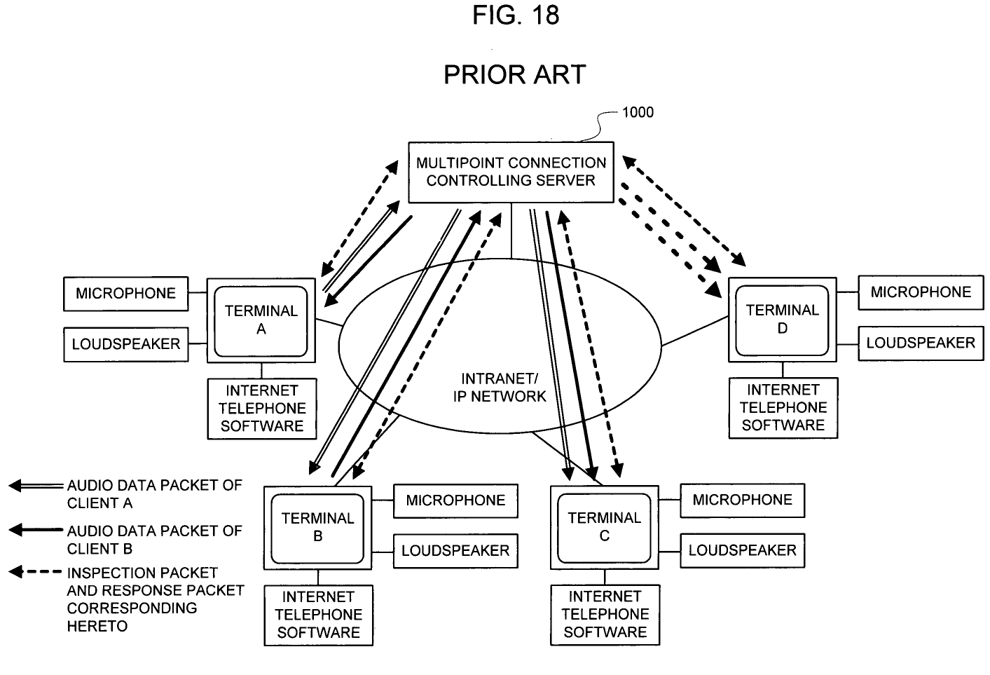

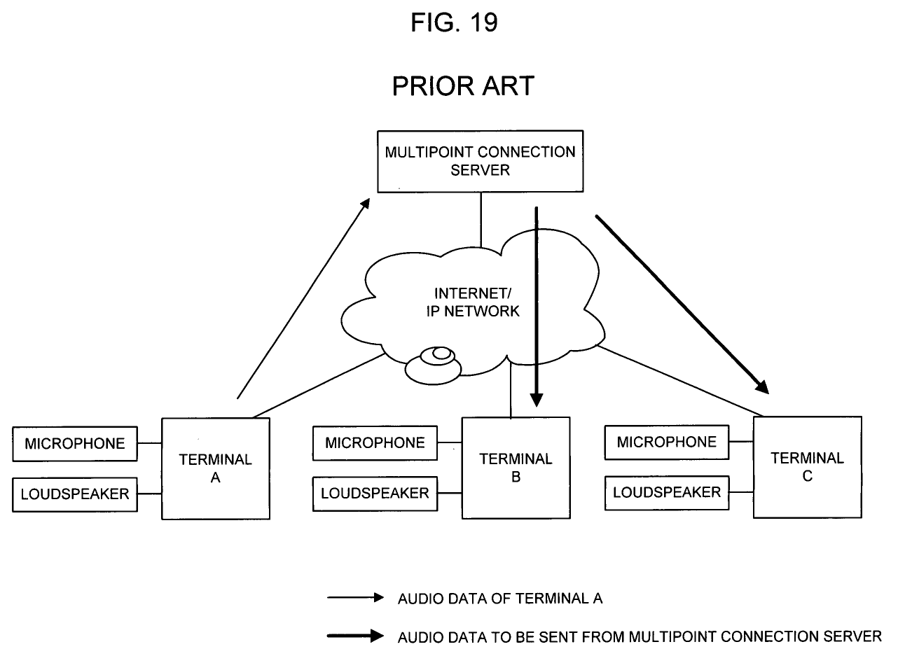

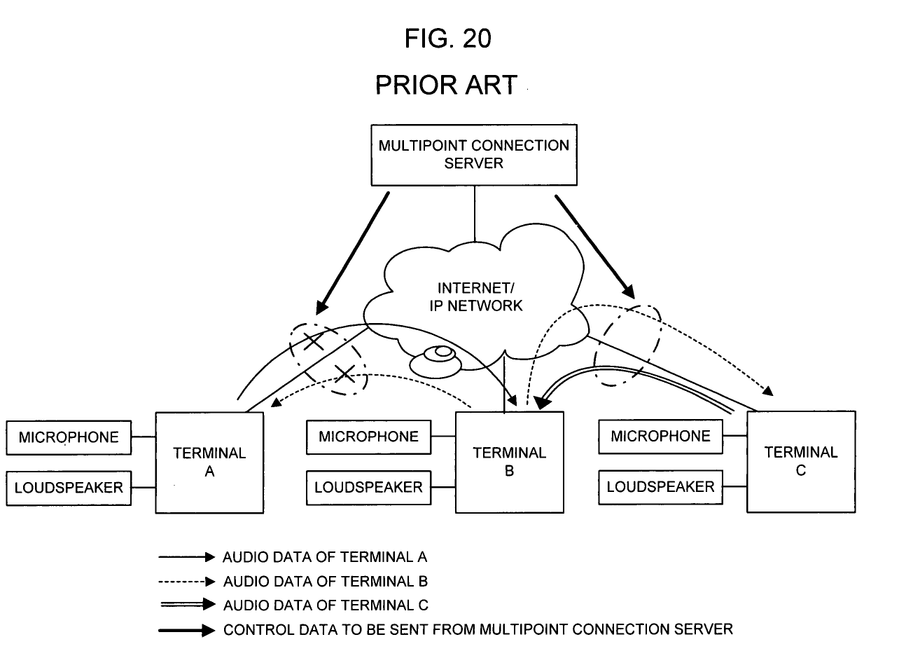

Next, an operation will be explained of a case where the terminal moves from the speaker group 5 to the listener group 6, by making a reference to FIG. 14 that is its sequence diagram.

The telephone conference has been already opened, so audio communication is currently being made from the multipoint connection controlling section 2 to the audio delivering server 108 via the second audio channel 17 (step S350), audio communication is currently being made from the audio delivering server 108 to the terminal B 119 via the audio delivery channel 19 (step S435), and audio communication is currently being made from the terminal B 119 to the multipoint connection controlling section 2 via the first audio channel 14 (step S805).

The telephone conference managing section 1 outputs a logical-channel disconnection request message for requesting a disconnection of the logical channel to the terminal B 119 to the multipoint connection controlling section 2 via the first control message path 8 (step S238).

Next, when the multipoint connection controlling section 2 inputs the logical-channel disconnection request message for requesting a disconnection of the logical channel to the terminal B 119 from the telephone conference managing section 1, it performs a process of disconnecting the first audio channel 14 to the terminal B 119 (step S351), and next performs a process of disconnecting the first control channel 13 to the terminal B 119 (step S352).

Next, the multipoint connection controlling section 2 outputs a logical-channel disconnection completion message indicating that a disconnection of the logical channel to the terminal B 119 was completed to the telephone conference managing section 1 via the first control message path 8 (step S353).

Next, the telephone conference managing section 1 outputs a message for requesting a connection of the logical channel to the terminal B 119 to the listener managing section 4 via the third control message path 10 (step S239).

Next, when the listener managing section 4 inputs the message for requesting a connection of the logical channel to the terminal B 119 from the telephone conference managing section 1, it performs a process of connecting the fourth control channel 20 to the terminal B 119 (step S713), and next performs a process of exchanging ability with the terminal B 119 via the fourth control channel 20 (step S714), next performs a master-slave deciding process of, with the terminal B 119, deciding that the listener managing section 4 has a leadership in taking a control via the fourth control channel 20 (step S715), next performs a process of connecting the third audio channel 21 to the terminal B 119 (step S716), and next outputs a logical-channel connection completion message indicating that a connection of the logical channel to the terminal B 119 was completed to the telephone conference managing section 1 via the third control message path 10 (step S717).

Next, the telephone conference managing section 1 performs a process of updating information associated with the terminal B 119 filed in the participant DB 102 (step S240), and thereby, the terminal B 119 becomes a terminal belonging to the listener group 6 (step S806), and the listener managing section 4 comes to receive the audio packet, which the above terminal transmits, via the third audio channel 21 (step S807).

By the sequence above, it is realized that the terminal, which belonged to the speaker group 5, moves to the listener group 6.

In this embodiment, for example, in a case where a terminal moved from the listener group 6 to the speaker group 5, by taking a means for allowing the above terminal to recognize its fact, the terminal is able to recognize that its own terminal belongs to the speaker group 5, in addition to recognizing its fact by receiving the audio data spoken via its own terminal. Specifically, the multipoint connection controlling section 2, which received the control message from the telephone conference managing section 1, makes a connection to the first control channel 13 (step S345) or disconnects the connection to the first control channel 13 (step S352), thereby a movement is made of the terminal from the listener group 6 to the speaker group 5, or a movement is made of the terminal from the speaker group 5 to the listener group 6 correspondingly; however each terminal recognizes that its own terminal belongs to the speaker group 5 by means of a signal to the effect of making a connection to the first control channel 13, and recognizes that its own terminal belongs to the listener group 6 by means of a signal to the effect of disconnecting the connection to the first control channel 13. Each terminal, which is a terminal to be configured of a general-purpose computer system that is available also as an IP telephone provided with a display or a loudspeaker, may inform a terminal user of the group to which its own terminal belongs by means of a singing operation or a screen display.

In this embodiment, in a case where the terminal belonging to the listener group 6 makes a speech, it becomes necessary to move this terminal to the speaker group 5, and a terminal management at this time is made at the moment that the speech of the terminal was detected (the step S709 in FIG. 13) and the telephone conference managing section 1 received a notification of attribute information of the terminal that made a speech.

In a case where a plurality of the terminals belonging to the listener group 6 made a speech, the listener managing section 4 selects either of them; however as a selection criterion at this time, is listed the criterion of selecting the terminal of which the speech times are numerous within a unit time, the criterion of selecting the terminal of which the speech times are numerous since the conference started, the criterion of selecting the terminal of which attendance times in the speaker group 5 are few since the conference started, or the like, and selection may be made according to a predetermined rule.

Also, in a case where the number of the terminals, which are allowed to be accommodated in the speaker group 5, reached its limit, so as to move a new terminal to the speaker group 5 from the listener group 6, a step is taken of selecting any one of the terminals, which have been accommodated in the speaker group 5, to move the above terminal belonging to the speaker group 5 to the listener group 6 according to the sequence shown in FIG. 14. Also in this selection, is selected the terminal of which the speech times are few within a unit time, the terminal of which the speech times are few since the conference started, the terminal of which attendance times in the speaker group 5 are numerous since the conference started, or the like.

In a case (method 1) of selecting the terminal with a criterion of the speech times within a unit time up to now, the speaker who can be regarded as a speaker having much interest or less interest in a theme, which is currently being discussed, can be selected.

In a case (method 2) of selecting the terminal with a criterion of the speech times since the conference started, the terminal of the participant group 7 makes a speech responding to the speech times, which enables a form matched with the actual conference proceedings to be assumed.

In a case (method 3) of selecting the terminal with a criterion of the attendance times in the speaker group 5 since the conference started, a right to speak can be given to each terminal equally.

Also, as to a movement from the listener group 6 to the speaker group 5, and a movement from the speaker group 5 to the listener group 6, there is no necessity for giving commonality to these movements, for example, the method 1 may apply to a movement from the listener group 6 to the speaker group 5, and the method 3 may apply to a movement from the speaker group 5 to the listener group 6, that is, various methods may be appropriately selected, in consideration of the nature of its conference.

The above explanation was made on the consumption that the multipoint connection controlling section 2 was in a state where it had the terminals of the maximum accommodation terminal number close to a limit of its processing ability already connected.

The maximum accommodation terminal number of the multipoint connection controlling section 2, which indicates the terminal number that is allowed to belong to the speaker group 5, is decided based upon the following parameters.

(1) A processing ability as a telephone conference server:

“A routine for expanding the audio packet” or “a routine for making a mixing” has to be started by a portion of the above limited number in the multipoint connection controlling section 2, the number of each routine, which can be started with the processing ability of the telephone conference server 126, is restrained, and the number of the terminals, which are allowed to belong to the speaker group is constrained.

(2) A time required until listening to a speech after making a speech (delay time):

1. The more closely the throughput nears to a limit of the processing ability of the telephone conference server, the longer the processing time required for “a routine for expanding the audio packet” or “a routine for making a mixing” becomes, thus increasing a time (delay time) required until listening to a speech after making a speech all the more.

2. Further, the above-mentioned delay time is influenced by a load state of the communication network of the audio packet, and the more it receives a load, the more the delay time is increased.

(3) From a medical viewpoint of an ability limit of a cerebral auditory sense, the number of the talkers of which the difference can be distinguished by hearing is limited.

The maximum accommodation terminal number of the multipoint connection controlling section 2 is decided with the above-mentioned parameters. As described before, explanation is made on the consumption that the multipoint connection controlling section 2 is in a state where it has the terminals of the maximum accommodation terminal number close to a limit of its processing ability already connected. However, by making the limit number of the speaker's terminals smaller than the maximum number of the terminals, which are allowed to be accommodated, depending upon the processing ability of the multipoint connection controlling section 2, and yet by surely keeping connection resources empty at any time by at least one terminal portion, which are used for the terminal that moves from the listener group 6, just after a speech of a listener's terminal is detected, the above listener's terminal can be connected to the multipoint connection controlling section 2. Doing so makes it possible to take the effect that the time required for the process of moving the above terminal after the speech of the listener's terminal is detected can be shortened even though the number of the terminals to which the speaker's audio data can be transmitted at an identical time is reduced only by one or two.

Also, the speech of the listener's terminal is identified with the audio channel 16 established between each of the terminals belonging to the listener group 6 and the listener managing section 4; however so as to identify the speech of the listener's terminal at a highest speed, the terminal is preferably provided with a silence compression function (automated silence detecting function of preventing a silent packet from being sent out). The silence compression function allows the listener managing section 4 to identify the speech of the listener's terminal only by performing a process of identifying existence of reception of the speech audio data packet from the listener's terminal, which brings about the effect that the time required for a process of moving the terminal from the listener group 6 to the speaker group 5 can be shortened.

The present invention relates to the telephone conferencing system employing the IP telephone; however this IP telephone is not limited to a fixed telephone, and needless to say, it can apply to the telephone conferencing system employing a mobile telephone.

Also, in the embodiment, the telephone conferencing system employing the audio data was explained; however data obtained by adding the audio data for which a mixing by the present invention was made to moving picture data also can be applied for a television telephone conferencing system, a remote teaching system, an electronic government, an electronic autonomy, or the like.

1. A multipoint conferencing system for allowing a conference to be held among a plurality of terminals capable of making communication via an IP network, said multipoint conferencing system comprising:
a telephone conference server for, out of said plurality of said terminals, recognizing the terminal participating in the conference as a terminal belonging to either a speaker group or a listener group, and for generating audio data by making a mixing of audio data from the terminals belonging to said speaker group; and
a audio delivering section for delivering the audio data for which a mixing was made by said telephone conference server to terminals belonging to said speaker group and said listener group.

2. The multipoint conferencing system according to claim 1, wherein said telephone conference server manages opening and ending of the telephone conference, a participation of the terminals in the conference, a withdrawal thereof from the conference, a movement thereof from the speaker group to the listener group, and a movement thereof from the listener group to the speaker group, and generates audio data by making a mixing of the audio data of the terminals which currently belong to the speaker group.

3. The multipoint conferencing system according to claim 2, wherein said telephone conference server makes selection of a terminal based upon the number of speech times in an arbitrary time zone, said terminal moving from the speaker group to the listener group.

4. The multipoint conferencing system according to claim 2, wherein said the telephone conference server makes selection of a terminal based on the number of speech times since the conference started, said terminal moving from the speaker group to the listener group.

5. The multipoint conferencing system according to claim 2, wherein said telephone conference server makes selection of a terminal based on the number of attendance times in the speaker group since the conference started, said terminal moving from the speaker group to the listener group.

6. The multipoint conferencing system according to claim 2, wherein said telephone conference server makes selection of a terminal based on the number of speech times in an arbitrary time zone, said terminal moving from the listener group to the speaker group.

7. The multipoint conferencing system according to claim 2, wherein said telephone conference server makes selection of a terminal based on the number of speech times since the conference started, said terminal moving from the listener group to the speaker group.

8. The multipoint conferencing system according to claim 2, wherein said telephone conference server makes selection of a terminal based on the number of attendance times in the speaker group since the conference started, said terminal moving from the listener group to the speaker group.

9. The multipoint conferencing system according to claim 1, wherein said terminal belonging to either the speaker group or the listener group is configured so that a signal from the telephone conference server enables the terminal itself to recognize which group it belongs to, and comprises a display for showing which group it belongs to.

10. A configuration method of a multipoint conferencing system for allowing a conference to be held among a plurality of terminals capable of making communication via an IP network, said configuration method of said multipoint conferencing system characterized in that out of said plurality of said terminals, the terminal participating in the conference is recognized as a terminal belonging to either a speaker group or a listener group, and that audio data generated by making a mixing of the audio data from the terminals belonging to said speaker group is delivered to the terminals belonging to said speaker group and said listener group.

11. The configuration method of the multipoint conferencing system according to claim 10, wherein said telephone conference server manages opening and ending of the telephone conference, a participation of the terminals in the conference, a withdrawal thereof from the conference, a movement thereof from the speaker group to the listener group, and a movement thereof from the listener group to the speaker group, and generates audio data by making a mixing of the audio data of the terminals which currently belong to the speaker group.

12. The configuration method of the multipoint conferencing system according to claim 11, characterized in that selection is made of a terminal based on the number of speech times in an arbitrary time zone, said terminal moving from the speaker group to the listener group.

13. The configuration method of the multipoint conferencing system according to claim 11, characterized in that selection is made of a terminal based on the number of speech times since the conference started, said terminal moving from the speaker group to the listener group.

14. The configuration method of the multipoint conferencing system according to claim 11, characterized in that selection is made of a terminal based on the number of attendance times in the speaker group since the conference started, said terminal moving from the speaker group to the listener group.

15. The configuration method of the multipoint conferencing system according to claim 11, characterized in that selection is made of a terminal based upon the number of speech times in an arbitrary time zone, said terminal moving from the listener group to the speaker group.

16. The configuration method of the multipoint conferencing system according to claim 11, characterized in that selection is made of a terminal based on the number of speech times since the conference started, said terminal moving from the listener group to the speaker group.

17. The configuration method of the multipoint conferencing system according to claim 11, characterized in that selection is made of a terminal based on the number of attendance times in the speaker group since the conference started, said terminal moving from the listener group to the speaker group.

18. The configuration method of the multipoint conferencing system according to claim 10, characterized in that the terminal belonging to either the speaker group or the listener group is configured so that a signal from the telephone conference server enables the terminal itself to recognize which group it belongs to, and comprises a display for showing which group it belongs to.
